(19) United States
(12) Patent Application Publication
(10) Pub. No.: US 2004/0049471 A1
(43) Pub. Date: Mar. 11, 2004

(54) Method for processing and delivering registered mail

(75) Inventor: Leon A. Pintsov, West Hartford, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/238,405

(22) Filed: Sep. 10, 2002

(51) Int. Cl. G06F 17/00

(52) U.S. Cl. 705/406; 705/410

(57) ABSTRACT

Radio frequency identification tags are placed on mail pieces to uniquely identify registered mail pieces. The unique identifier is stored in a first computer and then communicated to a second computer. The radio frequency identification tag is then scanned at selected locations as the mail piece travels through the delivery process. Then the information scanned at the selected locations including the location of the scanner is communicated to the second computer as the mail piece travels through the delivery process.

### CROSS REFERENCE TO RELATED APPLICATIONS

Reference is made to commonly assigned co-pending patent applications Docket No. F-457 filed herewith entitled “Method For Detecting And Redirecting Misdirected Mail” in the names of Ronald P. Sansone, Claude Zeller, Robert A. Cordery, Marc Morelli, Arthur Parkos, Leon A. Pintsov, Ronald Reichman; Docket No. F-484 filed herewith entitled “Method For Detecting And Redirecting Major Mailer's Special Service Mail” in the name of Ronald P. Sansone; and Docket No. F-538 filed herewith entitled “Method For Maintaining The Integrity Of A Mailing Using Radio Frequency Identification Tags” in the names of Leon A. Pintsov, Kenneth G. Miller, Kwan Cheung Wong and John H. Winkelman.

### FIELD OF THE INVENTION

The invention relates generally to the field of mailing systems and, more particularly, to systems for locating mail.

### BACKGROUND OF THE INVENTION

Governments have created post offices for collecting, sorting and distributing the mail. The post offices typically charges mailers for delivering the mail. Mailers may pay the post office for this service by purchasing a stamp, i.e., a printed adhesive label, issued by the post office at specified prices that is affixed to all letters, parcels or other mail matter to show prepayment of postage.

The United States Postal Service (USPS) currently handles large volumes of normal mail, i.e., first class mail, standard A mail, standard B mail, etc. However when it comes to special service mail, i.e., registered mail, etc., the USPS uses gummed service stickers and forms to indicate and process the special service mail. The use of gummed service stickers and completion of forms by hand is time consuming, error prone and raises the expense for receiving these services. Furthermore, the use of registered mail requires the mailer to physically deliver the mail piece to the clerk in the lobby of the USPS.

Registered mail is the most secure service that the USPS offers. It incorporates a system of written receipts to monitor the movement of the mail from the point of acceptance by the postal lobby clerk to delivery to the recipient.

Registered mail service provides the sender with a mailing receipt and at least a minimal insurance for the value of the article being mailed. The USPS also maintains a written record of the custody of the mail as the mail travels through the postal system to the recipient.

A disadvantage of the prior art is that once a registered mail piece is accepted by the USPS and placed in a bag, the USPS has to open the bag to determine that the mail piece is in the bag or provide assurances to that effect by inspectors who monitor the sealed bag containing registered mail. The foregoing process is labor intensive, time consuming and expensive.

### SUMMARY OF THE INVENTION

This invention overcomes the disadvantages of the prior art by utilizing a system that enables registered mail to be detected automatically at various locations and then storing the location of places that the mail was detected as the mail moves through the delivery process.

The foregoing is accomplished by placing radio frequency identification tags on mail pieces to uniquely identify registered mail pieces. The unique identifier information is stored in a first computer and then communicated to a second computer. The radio frequency identification tag is then scanned at selected locations as the mail piece travels through the mail sorting, transportation and delivery processes. Then the information scanned at the selected locations, including information indicative of the location of the scanner, is communicated to the second computer as the mail piece travels through the delivery process.

### BRIEF DESCRIPTION OF THE DRAWINGS

FIG. 1 is a drawing of a mail piece having a radio frequency identification tag;

FIG. 2 is a drawing showing the steps in the delivery of registered mail;

FIG. 3 is a drawing showing the record computer 50 (FIG. 2) has stored for mail piece 11 (FIG. 1) as mail piece 11 exited a typical destination Post Office; and

FIG. 4 is a drawing of RFID data processing block 200 of FIG. 2 in greater detail.

### DETAILED DESCRIPTION OF THE PREFERRED EMBODIMENT

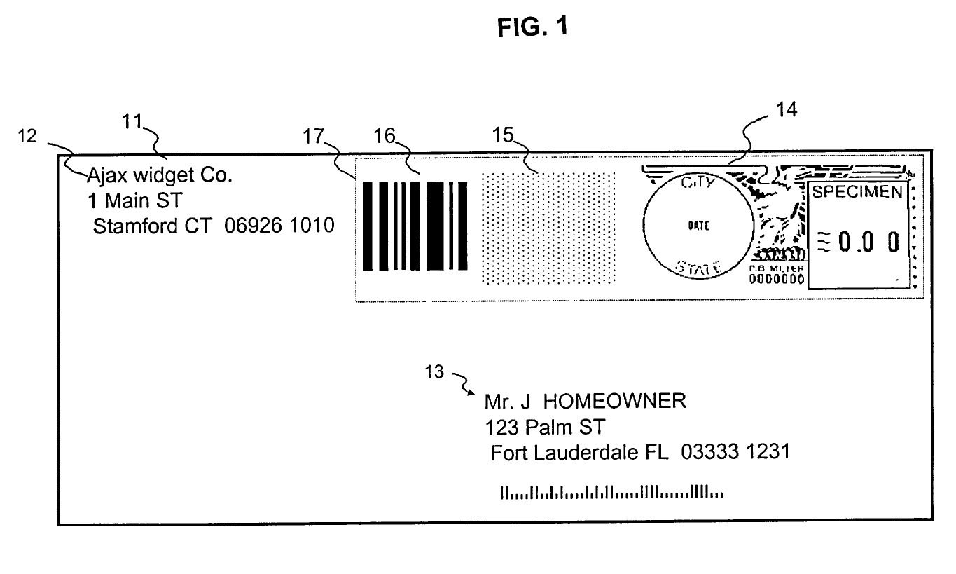

Referring now to the drawings in detail and more particularly to FIG. 1, the reference character 11 represents a mail piece that has a sender address field 12, a recipient address field 13, a postal indicia 14, a radio frequency identification tag 15, and a bar code 16 that contains specified information. Radio frequency identification (RFID) tag 15 may be the 4×6 RFID Smart Label Philips manufactured by RAFEC USA of 999 Oakmont Plaza Drive, Suite 200, Westmont, Ill. 60559. The information contained in tag 15 is the sender address field 12, recipient address field 13, the type of special service to be performed by the carrier, i.e., registered mail, and the mailer's declared value of the contents of the mail piece. The information contained in tag 15 may be encrypted or digitally signed for the purpose of protecting the information stored in tag 15 from unauthorized use. It would be obvious to one skilled in the art that other information may be used to uniquely define mail piece 11. The information written into tag 15 may be by a radio frequency identification tag printer (not shown). The radio frequency identification tag printer may be the Zebra R140 printer manufactured by Zebra Technologies Corporation of 333 Corporate Woods Parkway, Vernon Hills, Ill., 60061. Indicia 14 and tag 15 may be placed on a paper tape 17 that is adhered to mail piece 11, or indicia 14 may be printed directly on mail piece 11, and tag 15 adhered to mail piece 11.

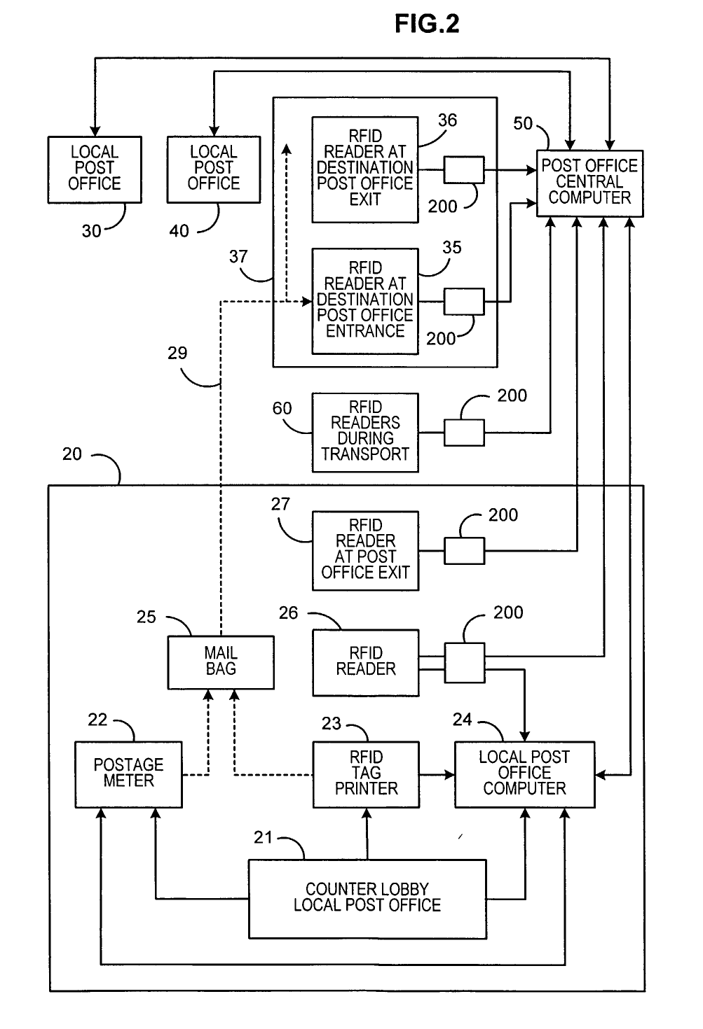

FIG. 2 is a drawing showing the steps in the delivery of registered mail. When a mailer wanted to send a mail piece by using registered mail service, the mailer would bring the mail piece to counter lobby 21 of local post office 20. The mailer would inform the postal clerk of the value of the contents of the mail piece. Then the clerk at counter 21 would utilize local post office computer 24 to determine the amount of postage required to mail the mail piece as registered mail. Postage meter or value label printer 22 would print postal or similar indicum 14 (FIG. 1) with the correct amount of postage and bar code 16 on paper tape 17 (FIG. 1). Local computer 24 will communicate with post office central computer 50 and postage meter 22 to determine the information that will be placed in tag 15. RFID tag printer 23 would place the aforementioned information into tag 15. Tag 15 would then be affixed to paper tape 17. Printer 23 may be the Zebra model R140 manufactured by Zebra Technologies Corporation of 333 Corporate Woods Parkway Vernon Hills, Ill. 60061-3109.

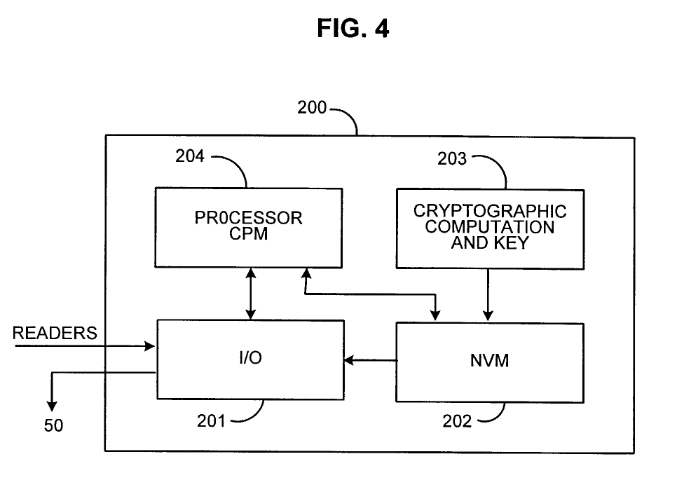

At this point, the postal clerk would place mail piece 11 (FIG. 1) in mail bag 25. Other registered mail pieces going to the same destination as mail piece 11 will be placed in mail bag 25. Mail bag 25 would then be sealed, and RFID reader 26 would read the information contained in one or more tags 15 and transmit the information to RFID data processing block 200 (which is hereinafter described in the description of FIG. 4) where the information would be protected against unauthorized use. RFID data processing block 200 would send the information that was read as well as identify the location of reader 26 to local computer 24 and central computer 50. Computers 24 and 50 would store the aforementioned information, time stamp the information to indicate when the information was read, and to identify and locate reader 26. As mail bag 25 exits post office 20, RFID reader 27 at the post office exit would read the information contained in one or more tags 15 and transmit the information to RFID data processing block 200 where the information would be protected against unauthorized use. Block 200 would send the information that was read, as well as the identity and location of reader 27 to central computer 50. Central computer 50 will acknowledge to local computer 24 the information it receives concerning all RFID tags on all registered mail pieces posted at local post office 20.

A plurality of RFID readers during transport 60 is positioned at various locations along the delivery path 29. At a minimum, at least one RFID reader 60 is positioned at every location in which mail bag 25 is expected to experience a change in mode of transportation, i.e., from truck to airplane, from truck to train, from airplane to truck, or other significant changes, for example a change in control from one entity to another. At least one RFID reader 60 is positioned at the entrance and exit of every postal facility that mail bag 25 will enter and exit. RFID readers 60 may also be in the physical possession of every postal employee that will handle mail bag 25. Every time a RFID reader 60 reads the tags 15 that are contained in mail bag 25, that RFID reader 60 will communicate the information stored in tags 15 to RFID data processing block 200 for protection of the information. RFID data processing block 200 will transmit the information scanned from tags 15 and the location of RFID reader 60 to central computer 50. Computer 50 will store the time that it receives a communication from any RFID reader by time stamping the receiving event.

RFID reader 35 located at the entrance of the destination post office 37 will read the information stored in tags 15 and communicate in a secure manner via block 200, e.g., digitally signed the read information as well as the identity of the location of reader 35 to computer 50. Computer 50 will store the aforementioned information together with its time of arrival. Mail bag 25 will be opened in destination post office 37, and mail piece 11 (FIG. 1) will be removed from mail bag 25 and given to a local postal carrier for delivery to the recipient identified in recipient address field 13. When mail piece 11 departs from destination post office 37, RFID reader 36 at the exit of destination post office 37 will read the information stored in tag 15 and communicate the read information stored in tags 15 to RFID data processing block 200 for protection of the information. Block 200 will transmit the above information as well as the location of reader 35 to computer 50. Computer 50 will store the aforementioned information together with its time of arrival. When the local letter carrier delivers mail piece 11 to the recipient identified in recipient address field 13, the local letter carrier may have a RFID reader that reports the delivery of mail piece 11 to the recipient and/or have the recipient sign a receipt that indicates the acceptance of mail piece 11. Radio frequency identification (RFID) readers 26, 27, 35, 36 and 60 may be the model SL EV900 reader manufactured by Philips Semiconductors of 1109 McKay Drive, San Jose, Calif. 95131.

Local post office 30 is coupled to computer 50, and local post office 40 is coupled to computer 50. Computer 50 and local post offices 30 and 40 will operate in the same manner described for local post office 20.

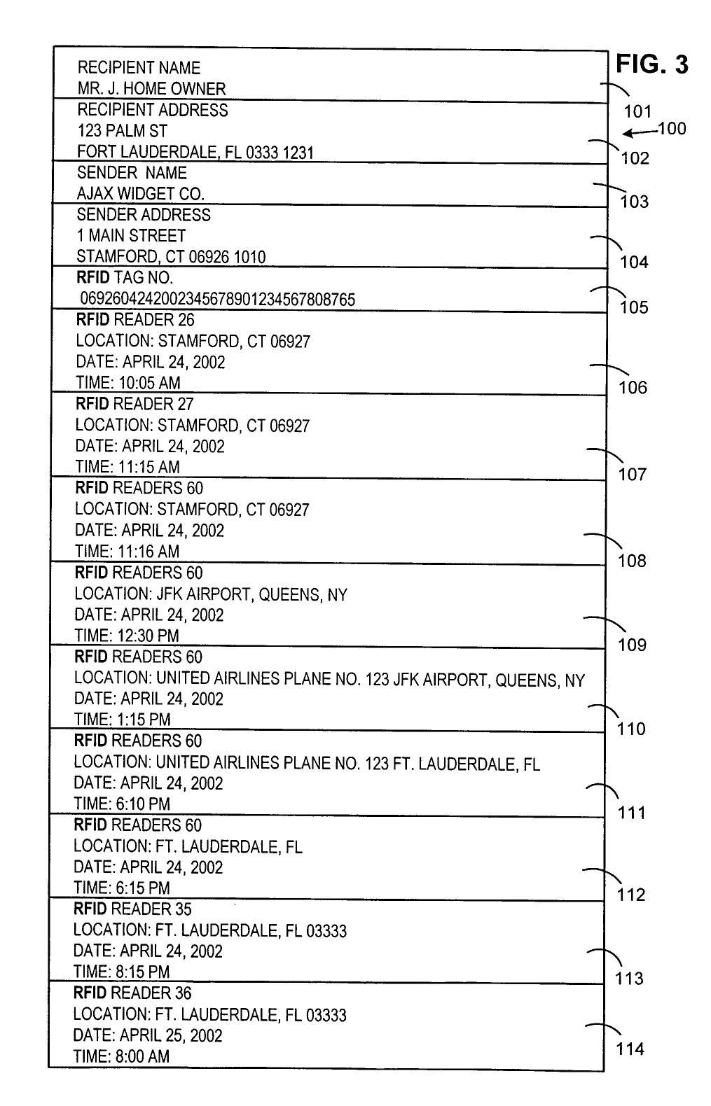

FIG. 3 is a drawing showing the record 100 computer 50 (FIG. 2) has stored for mail piece 11 (FIG. 1) as mail piece 11 exited a typical destination post office, for example, Ft. Lauderdale, Fla. The recipient's name is stored in block 101, and the recipient's address is stored in block 102. The sender's name is stored in block 103, and the sender's address is stored in block 104. Block 105 stores the RFID tag number as well as the declared and insured value of mail piece 11 and block 106 stores information regarding the location of RFID reader 26 and the date and time reader 26 read tag 15 that was affixed to mail piece 11. Block 107 stores information regarding the location of RFID reader 27 and the date and time reader 27 read tag 15 that was affixed to mail piece 11. Block 108 stores information regarding the date and time the reader 60 located on a vehicle, i.e. truck at Stamford, Conn., read tag 15 that was affixed to mail piece 11. Block 109 stores information regarding the date and time the reader 60, located at JFK Airport, Queens, N.Y., read tag 15. Block 110 stores information regarding the date and time the reader 60, located on United Airlines Plane No. 123 at JFK Airport, Queens, N.Y., read tag 15. Block 111 stores information regarding the date and time the reader 60, located on United Airlines Plane No. 123 at Ft. Lauderdale Airport, Fla., read tag 15. Block 112 stores information regarding the date and time the reader 60 located on a vehicle, i.e., truck at Ft. Lauderdale, Fla., read tag 15 that was affixed to mail piece 11. The location of RFID reader 35 and the date and time reader 35 read tag 15 are stored in block 113. The location of RFID reader 36 and the date and time reader 36 read tag 15 is stored in block 114.

The record 100 is continuously protected in computer 50 from accidental or deliberate modification by using information security techniques such as hashing, encryption and digital signatures.

FIG. 4 is a drawing of RFID data processing block 200 of FIG. 2 in greater detail. RFID block 200 is provided with I/O device 201, non-volatile memory 202, cryptographic computation and secure storage for keys 203 and processor 204. After the information stored in RFID tags 15 is scanned by readers 26, 27, 35, 36 and 60 (FIG. 2), the information enters block 200 via I/O 201. Then the information is stored in non-volatile memory 202. At this point the tag 15 information cannot be changed or altered deliberately or by accident. In the foregoing manner, the information stored in tags 15 concerning all mail in mail bag 25 is entered into non-volatile memory 202. When there is no more mail in bag 25, i.e., all mail has been scanned, non-volatile memory 202 supplies RFID tags 15 information to processor 204. Processor 204 also receives a (private) cryptographic key from cryptographic computation and secure storage for keys 203. Then processor 204 performs digital signature computations on the information that was stored in tags 15 before outputting the information through I/O 201. In this manner, all of the information is protected against alteration, and post office central computer 50 receives unaltered information from scanners 26, 27, 35, 36 and 60.

The method described in the present specification automatically monitors the progress of all registered mail through the postal delivery system. In doing so, a central computer can identify lost or stolen mail in a timely manner and alert postal personnel by sending automatic notices through any appropriate communication system, e.g., e-mail, telephone, facsimile, pagers, etc. The automatic notices may contain the identity and value of the lost or stolen mail together with the location of where the mail was last seen, the time it was last seen and when it was expected to arrive, if it had arrived. The manual investigation of the mail that did not arrive may then commence.

The above specification describes a new and improved method for processing registered mail. It is realized that the above description may indicate to those skilled in the art additional ways in which the principles of this invention may be used without departing from the spirit. Therefore, it is intended that this invention be limited only by the scope of the appended claims.

What is claimed is:

1. A method for processing registered mail, said method comprises the steps of:
A. placing a radio frequency identification tag on a mail piece that uniquely identifies the mail piece;
B. storing the unique identifier in a first computer;
C. communicating the stored unique identifier to a second computer;
D. scanning the radio frequency identification tag on the mail piece at selected locations as the mail piece travels through the delivery process; and
E. communicating the information scanned at the selected locations including the location of the scanner to the second computer as the mail piece travels through the delivery process.

2. The method claimed in claim 1, wherein the unique identifier includes the value of the mail piece.

3. The method claimed in claim 2, wherein the unique identifier includes information indicative of the postal service to be performed.

4. The method claimed in claim 1, wherein the unique identifier is digitally signed.

5. The method claimed in claim 1, wherein the unique identifier is encrypted.

6. The method claimed in claim 1, wherein the value of the mail piece is digitally signed.

7. The method claimed in claim 1, wherein the scanned information is digitally signed.

8. The method claimed in claim 1, wherein the scanned information is hashed.

9. The method claimed in claim 1, wherein the scanned information is encrypted.

10. The method claimed in claim 1, wherein the unique identifier is digitally signed to protect unauthorized alteration of the unique identifier.

11. The method claimed in claim 1, further including the step of:
communicating the scanned information received by the second computer from the second computer to the first computer as the mail piece travels through the delivery process.

12. The method claimed in claim 11, further including the step of:
using the information received by the second computer from the first computer to locate a missing mail piece.

13. The method claimed in claim 12, further including the step of:
printing the scanned information received by the second computer.

14. The method claimed in claim 13, further including the step of:
using the information printed by the second computer to locate a missing mail piece.

15. The method claimed in claim 1, further including the step of:
using the information received by the first computer to locate a missing mail piece.

16. The method claimed in claim 1, further including the step of:
printing the scanned information received by the first computer.

17. The method claimed in claim 16, further including the step of:
using the information printed by the first computer to locate a missing mail piece.

18. The method claimed in claim 1, further including the step of:
reporting the location of each read radio frequency identification tag to the carrier.

19. The method claimed in claim 1, wherein the communicating step further including the step of:
communicating the date and time that the scanners at the selected locations scanned the mail piece to the second computer as the mail piece travels through the delivery process.
